(19) United States
(12) Patent Application Publication
(10) Pub. No.: US 2007/0273173 A1
(43) Pub. Date: Nov. 29, 2007

(54) Aircraft Sun Visor

(75) Inventor: John Guy Cazort III, Corona del Mar, CA (US)

Correspondence Address: JOHN GUY CAZORT III, 3501 SEABREEZE LANE, CORONA DEL MAR, CA, 92625, US

(73) Assignee: Cazort Technologies, Inc, Corona del Mar, CA (US)

(21) Appl. No.: 11/277,195

(22) Filed: Mar. 22, 2006

(51) Int. Cl. B60J 3/02; B60J 3/06

(52) U.S. Cl. 296/97.2

(57) ABSTRACT

An aircraft sun visor comprising: a generally flat visor means with an approximate size to cast a shadow to comfortably shade the pilot's eyes from the sun while creating minimal blockage of windshield and outside obstacles, a suction cup or plurality of suction cups to attach said sun visor to windshield at any location on the inside of the windshield to accommodate sun position relative to pilot or crew.

### BACKGROUND OF THE INVENTION

It is stated in the Federal Aviation Regulations “vigilance shall be maintained by each person operating and aircraft so as to see and avoid other aircraft”. This see and avoid action is the primary method to avoid near misses and or mid-air collisions.

Because the eye can focus only on a narrow viewing area, it is encouraged that pilots employ a scanning procedure where they use a series of short, regularly spaced eye movements to scan the entire viewable area outside the aircraft. This works most of the time but becomes difficult while flying towards the sun or while the sun is viewable through the windshield.

Most aircraft are equipped with padded sun visors similar to those used in automobiles that are attached near the upper portion of the windshield. At least one company manufactures smoked transparent sun visors that attach to the upper portion of the cabin near the windshield that can swing down when needed. With the smoked visor it is intended that the operator can still see other aircraft through the visor but will be shielded from the sun's glair. Both above mentioned executions of the sun visor lend personal comfort to the operator but have the drawback of either completely blocking a large area of the sky or at least making the visibility poor. Even with the smoked transparent visor it is neither comfortable nor recommended to look directly at the sun, thus reducing the possibility of seeing aircraft in that general direction. Typically a sun visor with a solid attachment needs to be larger to be able to give shade in the desired area. Also when the sun is very low the visor needs to block the majority of the view to give the desired shade.

### SUMMARY OF THE INVENTION

The sun visor of the present invention is an aircraft sun visor comprising: a generally flat visor means with an approximate size to cast a shadow to comfortably shade the pilot's eyes from the sun while creating minimal blockage of windshield and outside obstacles, a suction cup or plurality of suction cups to attach said sun visor to windshield at any location on the inside of the windshield to accommodate sun position relative to pilot or crew.

Unlike with automobiles traveling on curved roads, aircraft pilots typically will set a course and stay directly on that course for an extended period of time, thus reducing the need for the larger visor needed to continually shade the eyes of the operator whilst relative movement to the sun is varied. As the sun gradually sets or rises, the present invention can be relocated anywhere on the windshield to block the sun's glare. Slight head movement of the operator will compensate for minor sun or aircraft movements.

### BRIEF DESCRIPTION OF THE DRAWINGS

FIG. 1 is an isometric view of the preferred embodiment.

FIG. 2 is a side view of the preferred embodiment.

FIG. 3 is a front view of the preferred embodiment.

FIG. 4A is how the invention will appear to the operator with the operator's right eye closed with an aircraft in the background.

FIG. 4B is how the invention will appear to the operator with the operator's left eye closed with an aircraft in the background.

FIG. 4C is how the invention will appear to the operator with both of the operator's eyes opened and focused on an aircraft outside in the background.

FIG. 5 is an alternate embodiment of the invention using spheres instead of discs.

FIG. 6 is an alternate embodiment of the invention using a printed flexible sheet of electrostatic plastic instead of solid discs.

### DETAILED DESCRIPTION OF THE DRAWINGS AND PREFERED EMBODIEMENTS

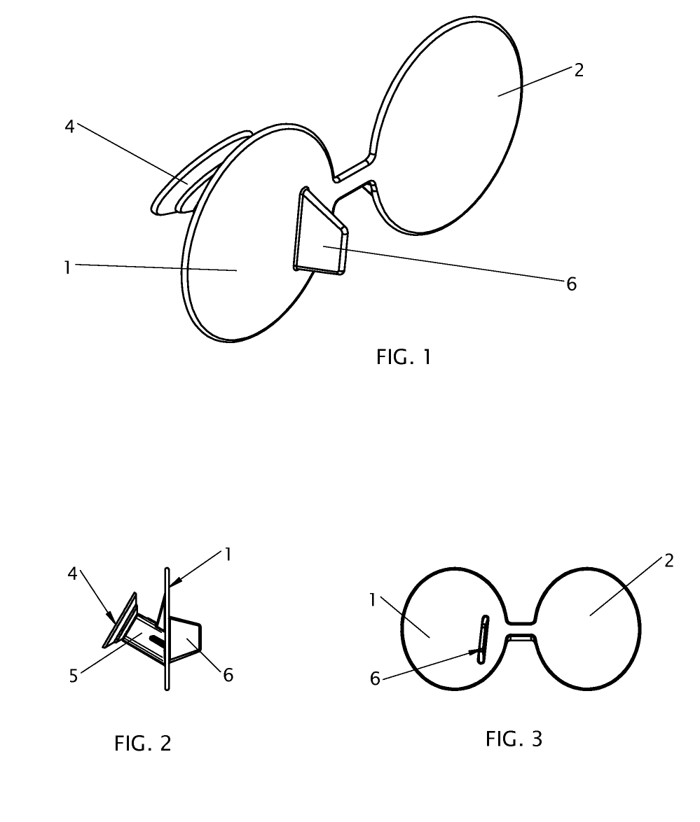

Although this invention may be a small rectangular shape (about the width of a human head and the height of a human eye socket) The preferred embodiment is a horizontal figure eight shape or may look like opaque spectacles with round lenses as shown in FIGS. 1 thru 3. The left disc 1 and right disc 2 of the figure eight cast a shadow of the sun on to the left and right respective eyes of the operator. The discs are small enough as to have minimal blockage of the view of the exterior of the aircraft yet are large enough to completely block the glare from the sun.

Mounting to the windshield is accomplished through the use of a suction cup 4 attached via a boss 5 with an angled base to hold the discs in a close to vertical position. This vertical position can be altered if the disks are made to be elliptical in shape to compensate for the angle of the said visor relative to the pilot. This method is used to cast a closer to round shadow while the sun is closer to the horizon. When the said sun visor is located low on the windshield, in it's most critical position, it will appear as round disks. When located high on the windshield it will appear as ellipses due to the relative position to the pilot. A handle 6 is included to facilitate manipulation and positioning of the said visor.

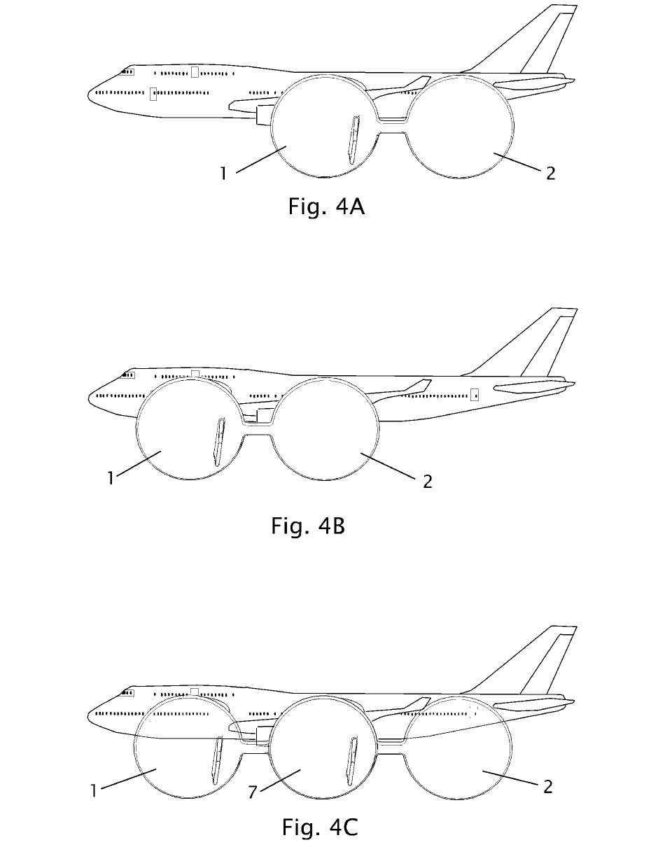

While focusing outside, looking for other aircraft, as shown if FIG. 4C, the shade will appear to be three discs due to the parallax effect. The two outside images will be ghost images (transparent images of the disk as seen by one eye combined with the outside view as seen by the other eye). The center image 7 will be solid with the sun directly behind and blocked. Stated another way: With the right eye closed the left eye will see two discs as in FIG. 4A. With the left eye closed the right eye will see two discs as in FIG. 4B, however, with both eyes open as shown in FIG. 4C, the left eye will see objects that the right eye cannot see due to the left disc, and the right eye will see objects that the left eye cannot see due to the right disc. For the operator, the only complete view blockage will be a single disc 7 covering the sun, allowing for maximum vision of the surrounding area.

Although this invention is intended for aircraft I have found it valuable while driving an automobile while on long straight roads. Several alternate embodiments are described below.

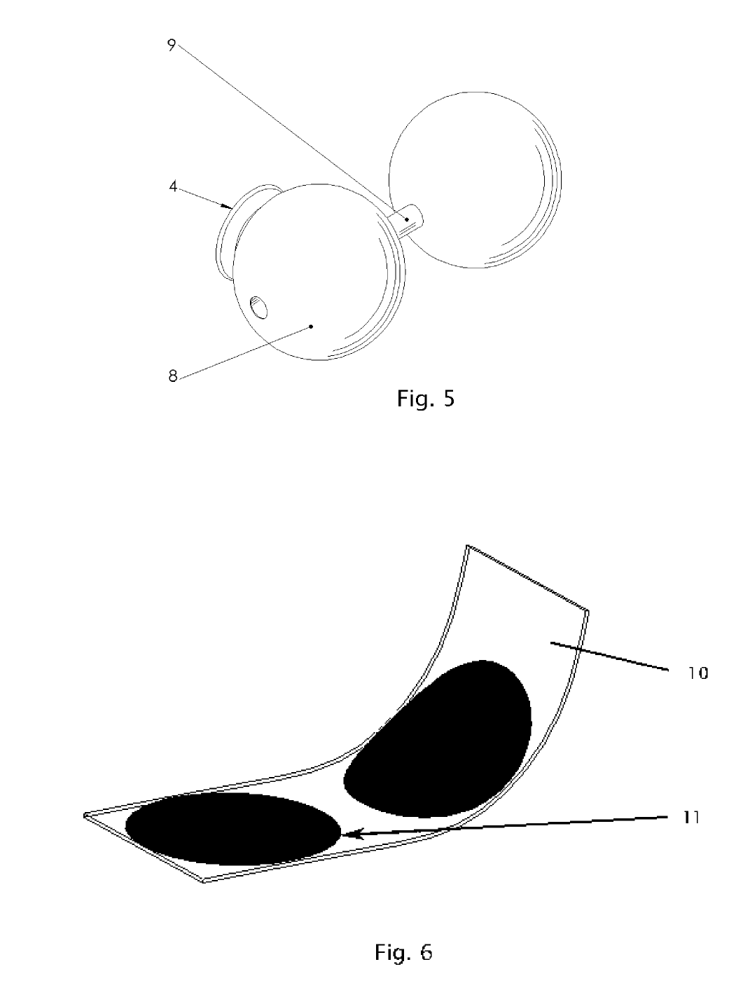

Rather than two flat discs, a three-dimensional shape consisting of two spheres 8 connected via a bar 9 can be used as shown in FIG. 5. Using this method there is no need for using the elliptical shape described in the above paragraph because the sphere will always cast a round shadow. The distance between the spheres can easily be can be adjusted by sliding them apart along a bar 9 which supports them and separates them. A suction cup attached to one or both spheres is used to attach the invention to the windshield.

Another alternate embodiment FIG. 6 can consist of a clear electrostatic sheet of plastic 10 with two printed opaque discs 11. These discs should be elliptical in shape to compensate for the angle of the windshield relative to the pilot. This sheet of plastic is applied directly to the windshield and can easily be removed and repositioned.

What is claimed is:

1. An aircraft or automobile sun visor comprising: a generally flat visor means with an approximate size to cast a shadow to comfortably shade the pilot's eyes from the sun while creating minimal blockage of wind screen and outside obstacles, a suction cup or plurality of suction cups to attach said sun visor to windshield at variable locations to accommodate sun position relative to pilot or crew.

2. The sun visor as set forth in claim 1 wherein the generally flat visor means consists of two separate circular discs, attached to each other, spaced horizontally apart the approximate distance to coincide with human eyes as to cast two separate discs of shadow individually upon the operator's eyes.

3. The sun visor as set forth in claim 2 wherein said circular discs are elliptical or polygonal in shape.

4. The sun visor as set forth in claim 2 wherein said circular discs are connected to form a figure eight shape.

5. The sun visor as set forth in claim 2 wherein said circular discs are separated and connected via a bar.

6. The sun visor as set forth in claim 2 wherein the distance of separation between discs is adjustable.

7. The sun visor as set forth in claim 1 wherein a handle is located on the opposite side of the said visor means from said suction cup for manipulation of location of said visor.

8. An aircraft or automobile sun visor comprising: a three-dimensional visor means with an approximate size to cast a shadow to comfortably shade the pilot's eyes from the sun while creating minimal blockage of wind screen and outside obstacles, a suction cup or plurality of suction cups to attach said sun visor to windshield at variable locations to accommodate sun position relative to pilot or crew.

9. The sun visor as set forth in claim 8 wherein said 3 dimensional visor means consists of two spheres or partial spheres spaced horizontally apart, the approximate distance to coincide with human eyes as to cast two separate discs of shadow individually upon the operator's eyes.

10. The sun visor as set forth in claim 9 wherein the distance of separation between said spheres is adjustable.

11. The sun visor as set forth in claim 9 wherein said spheres are separated and connected via a bar.

12. An aircraft or automobile sun visor comprising: A flexible electro static sheet of plastic with an opaque or a heavily translucent pattern of approximate size to cast a shadow to comfortably shade the pilot's eyes from the sun while creating minimal blockage of wind screen and outside obstacles.

13. The sun visor as set forth in claim 12 wherein said Opaque or heavily translucent pattern consists of two elliptical discs spaced and aligned along their minor axes the approximate distance to coincide with human eyes and each elliptical disk's minor axes having the approximate length or slightly larger than a human eye socket as to cast two separate discs of shadow individually upon the operator's eyes.

14. The sun visor as set forth in claim 12 wherein said Opaque or heavily translucent pattern consists of two circular discs spaced the approximate distance to coincide with human eyes and each disk's diameter having the approximate length or slightly larger than a human eye socket as to cast two separate discs of shadow individually upon the operator's eyes.
